(19) United States
(12) Patent Application Publication
(10) Pub. No.: US 2006/0226651 A1
(43) Pub. Date: Oct. 12, 2006

(54) Tamper proof, push-in, quick-connection of a tube to a fluid port

(75) Inventors: Jay P. Griswold, St. Charles, IL (US); Philip C. Hawken, Darien, IL (US)

Correspondence Address: REINHART BOERNER VAN DEUREN P.C., 483 NORTH MULFORD ROAD, SUITE 7, ROCKFORD, IL, 61107, US

(73) Assignee: Robertshaw Controls Company, Richmond, VA (US)

(21) Appl. No.: 11/094,096

(22) Filed: Mar. 30, 2005

(51) Int. Cl. F16L 21/06

(52) U.S. Cl. 285/322

(57) ABSTRACT

The distal end of a tube is operatively attached to a fluid port of a fluid element with a tamper-proof, non-releasable, push-in, quick connect apparatus having a flangeless collet, in such a manner that the flangeless collet cannot readily be moved with respect to the tube after the distal end of the tube is operatively attached to the port of the fluid element.

### FIELD OF THE INVENTION

This invention pertains to operative attachment of the distal end of a tube to a fluid element, and more particularly to making such an operative attachment with a push-in, quick-connect apparatus.

### BACKGROUND OF THE INVENTION

Releasable, push-in, quick-connect, fittings have been utilized for many years to provide a convenient means for attaching the distal ends of tubing to fluid ports in a fluid element. Such fittings are commercially available, for example, from such manufacturing sources as John Guest U.S.A., Inc. of Totowa, N.J. (acetal food-grade copolymer collet/cap system) or from Parker Hannifin Corporation of Ravenna, Ohio (“Parflex TrueSeal” line of quick-connect tubing fittings). The construction and operation of such fittings is also disclosed in U.S. Pat. Nos. 6,651,272, 6,193,879 and 5,944,985 to Bowman.

As shown in FIG. 1A, such fittings 10 typically include a cap-collar 12, and an O-ring 14, adapted for insertion, along an axis of insertion 16, into a fluid port 18 of a fluid element such as the fluid coupling 20 illustrated in FIG. 1A. The fitting 10 further includes a flanged collet 22, having a bore 24 extending therethrough from a flanged first end 26 of the collet 22 to a second end 28 of the collet 22 which is adapted for insertion into the cap-collar 12. The bore 24 is sized for receiving the distal end 30 of a tube 32.

The operation of such commercially available push-in quick-connect fittings 10 is shown semi-diagrammatically in the sequence of the views of FIGS. 1B-1F, respectively. To connect the distal end 30 of tube 32 to the quick-connect fitting 10, the cap-collar 12 and O-ring 14 are first installed into the fluid port 18, as shown in FIG. 1B. The collet 22 is then inserted into the cap-collar 14, as shown in FIG. 1C.

As shown in FIG. 1D, the distal end 30 of the tube 32 is then manually pushed along the axis of insertion 16 straight into and through the collet 22 until it abuts a stop shoulder 34 in the port 18. Barbs 38 (see also, FIG. 1A) extending from the inner periphery of the bore 24 in the collet 22 scrape along the outer surface of the tube 32 in such a manner that as the distal end 30 tube 32 is pushed through the collet 22 the collet 22 is pushed toward the cap-collar 12, until a release flange 36, extending radially from the first end 26 of the collet 22, is pressed against the cap-collar 12. The collet 22 and cap-collar 12 include complimentary ramp-like features 40, 42 (see also, FIG. 1A) on their outer and inner peripheries, respectively, which are disengaged from one another when the collet 22 is pushed toward the cap-collar 12 in the manner illustrated in FIG. 1D.

As shown in FIG. 1E, a slight separational pulling force is then manually exerted on tube 32 relative to the cap-collar 12. As the tube 32 is pulled away from the cap-collet 12, the barbs 38 on the collet 22 bite into the tube 32 in such a manner that the flange 36 of the collet 22 is pulled slightly away from cap-collar 12, thereby engaging and producing a wedging action between the cooperating ramp-like features 40, 42 on the collet 22 and the cap-collar 12, which in turn causes constriction of the second end 28 of the collet 22 in such a manner that the second end 28 of the collet 22 grips the tube 32 and causing the collet barbs to dig further into the tube 32.

As shown in FIG. 1F, to release the distal end 30 of the tube 32 from fitting 10, finger and/or thumb pressure is exerted on the flange 28 of collet 22 in such a manner that the collet 22 is pushed against the cap-collar 12, to the position shown in FIG. 1D, to thereby cause the complimentary ramp like features 40, 42 to disengage and release constriction the second end of the collet 22 onto the tube 30, such that the grip force exerted on the tube 32 by constriction of the collet 22 and deep engagement of the barbs 38 with the tube 32 are released, thereby freeing tube 30 to be pulled out of the collet 22 while the flange 36 of collet 22 is being held pushed in against cap-collar 12.

In some applications, however, experience has shown that having the fitting 10 be releasable is not desirable. Inside of a commercial or consumer appliance, such as a washing machine, for example, a number of fluid connections may need to be made between fluid elements such as control and mixing valves for hot and cold water, and air controlled elements such as diaphragm pressure actuated switches. While it is certainly convenient to have push-in, quick-connect fittings to facilitate OEM manufacture, having the fittings be releasable can result in improper and unnecessary connection and reconnection during servicing of the appliance in the field.

It is desirable, therefore, to provide an apparatus and method for attaching the distal ends of tubes to ports in their associated fluid elements, using tamper-proof fittings that allow for push-in quick-connection during initial attachment of the tube to the fluid element, but do not readily allow the tube to be released, once the tube has initially been attached to the fluid element.

### BRIEF SUMMARY OF THE INVENTION

In accordance with the invention, the distal end of a tube is operatively attached to a fluid port of a fluid element, using a push-in, quick connect apparatus having a flangeless collet, in such a manner that the flangeless collet cannot readily be moved with respect to the tube after the distal end of the tube is operatively attached to the port of the fluid element. Through practice of the invention, therefore, a tamper-proof, push-in, quick connection is provided between the tube and the fluid element.

In one form of the invention, a push-in quick-connect apparatus is provided for attaching a distal end of a tube to a fluid port of a fluid element, where the port defines an axis of insertion for the tube. The apparatus includes a flangeless collet including a substantially right circular cylinder-shaped sidewall disposed about a longitudinal axis. The sidewall has an inner surface and an outer surface thereof, extending along the longitudinal axis of the collet from a first to a second end of the collet. The inner surface of the sidewall defines a bore extending through the collet, along the longitudinal axis, and having a first axially facing opening at the first end of the collet, and a second axially facing opening at the second end of the collet. The collet is configured to receive the distal end of the tube at the first end of the collet, and to allow sliding passage of the distal end of the tube through the bore and beyond the second end of the collet, when the collar is not installed in the port, or when the collet is installed within the port and pushed in along the insertion axis to a tube insertion position within the port. The collet is further configured such that the collet grips the outer surface of the tube when the collet is pulled out along the insertion axis to a gripping position while installed in the port.

The collet may be configured, adjacent its second end, for gripping the outer surface of the tube when the collet is moved to the gripping position while the collet is installed in the port and the tube is extending through the bore in the collet. The outer surface of the sidewall, adjacent the second end of the collet, may include outwardly projecting ridges defining ramp surfaces oriented such that force applied to the ramp surface when the collet is moved toward the gripping position will cause the bore of the collet to be constricted adjacent the second end of the collet.

In some forms of the invention, an apparatus may further include a cap-collar adapted for attachment to the fluid element, and having a portion thereof configured for operatively engaging the collet when the collet is installed into the cap-collar. The outer surface of the sidewall of the collet, adjacent the second end of the collet, may include outwardly projecting ridges defining ramp surfaces oriented such that force applied to the ramp surface, when the collet is moved toward the gripping position, will cause the bore of the collet to be constricted adjacent the second end of the collet. The cap-collar may include an inner surface thereof that is adapted to operatively engage the ramp surfaces of the outwardly projecting ridges of the collet.

An apparatus, according to the invention, may include an o-ring packing, or other type of seal for providing a fluid seal between the port in the fluid element and the outer surface of the distal end of the tube.

The invention may also take the form of a method for attaching a distal end of a tube to a fluid port of a fluid element, by attaching the distal end of the tube to the port with a push-in, quick-connect apparatus having a flangeless collet. A method, according to the invention, may further include configuring the quick-connect apparatus in such a manner that the flangeless collet cannot readily be moved with respect to the tube, after the distal end of the tube is attached to the fluid element.

Other aspects, objectives and advantages of the invention will become more apparent from the following detailed description when taken in conjunction with the accompanying drawings.

### BRIEF DESCRIPTION OF THE DRAWINGS

FIG. 1A is a perspective illustration of a prior art releasable, push-in, quick-connect fitting.

FIGS. 1B-1E are orthographic cross-section illustrations of the prior art fitting shown in FIG. 1A, sequentially illustrating the manner in which a fitting in accordance with the prior art embodiment shown in FIG. 1A is utilized to attach a tube to a fluid element.

FIG. 1F is a cross-sectional illustration of the prior art fitting illustrated in FIGS. 1A-1E, showing the manner in which the tube may be released from attachment with the fluid element, by applying thumb or finger pressure to a flange of a collet of the prior art fitting.

FIG. 2A is a perspective illustration of an exemplary embodiment of a tamper-proof, push-in, quick-connect fitting, according to the invention.

FIGS. 2B-2E are orthographic cross-sections of the tamper-proof fitting, of the exemplary embodiment of the invention shown in FIG. 2A, successively illustrating the manner in which the invention may be utilized to form a tamper-proof connection between the tube and the fluid element.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

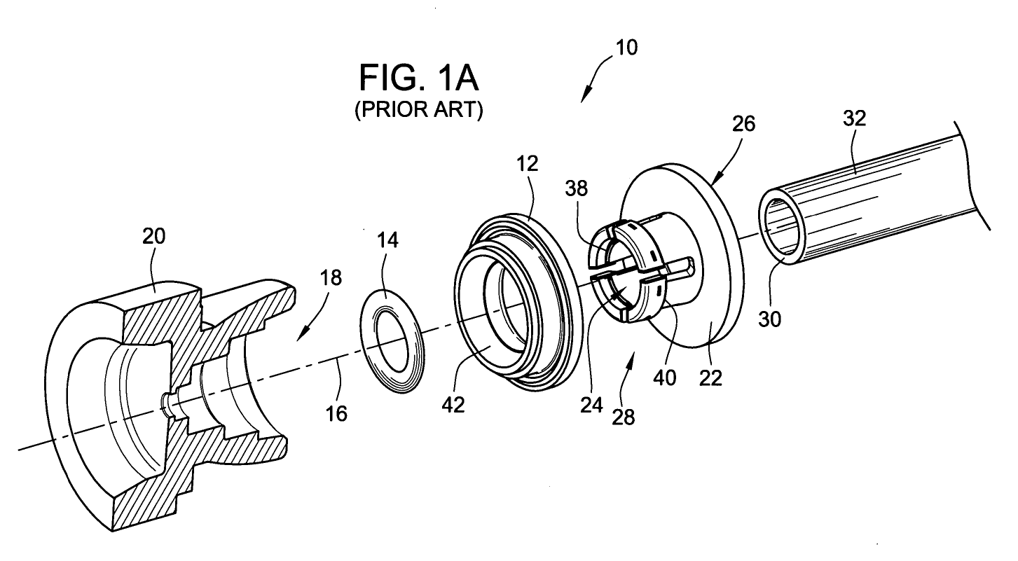

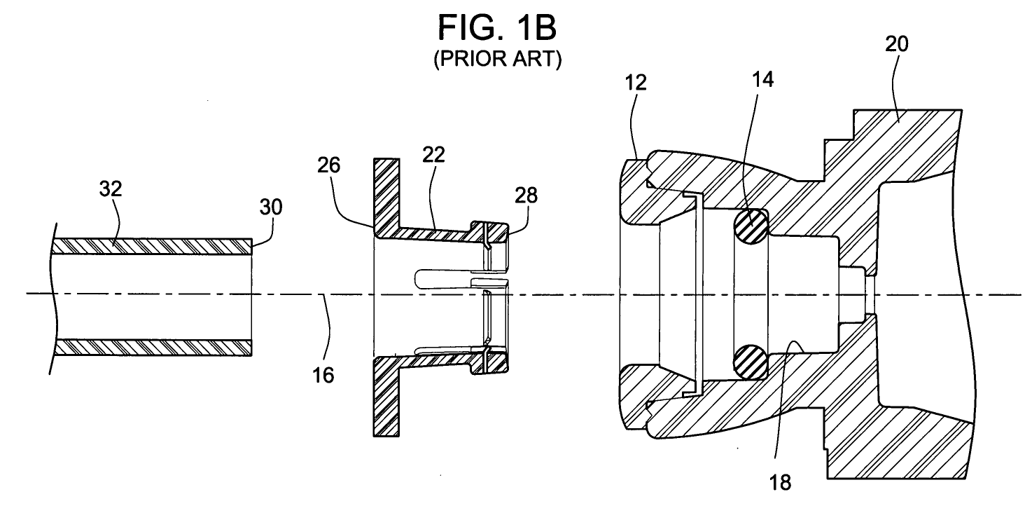

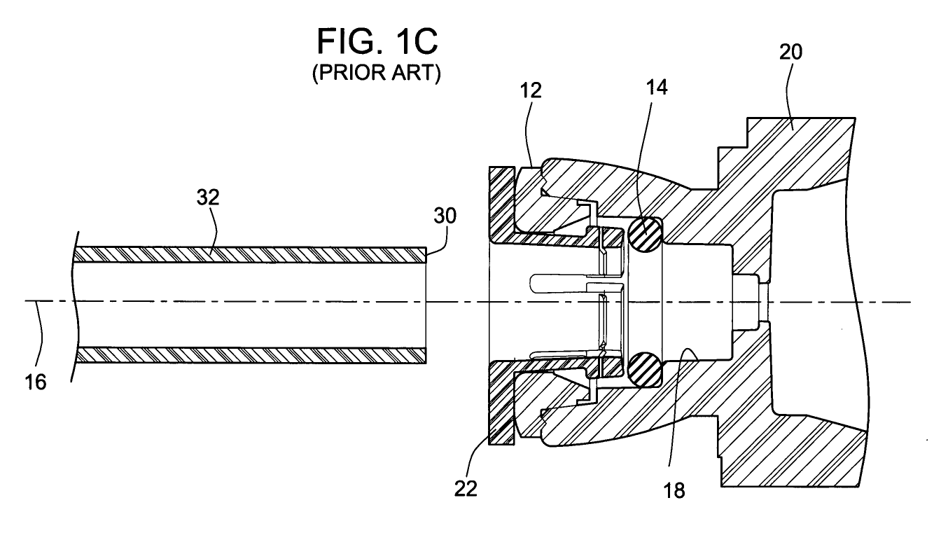

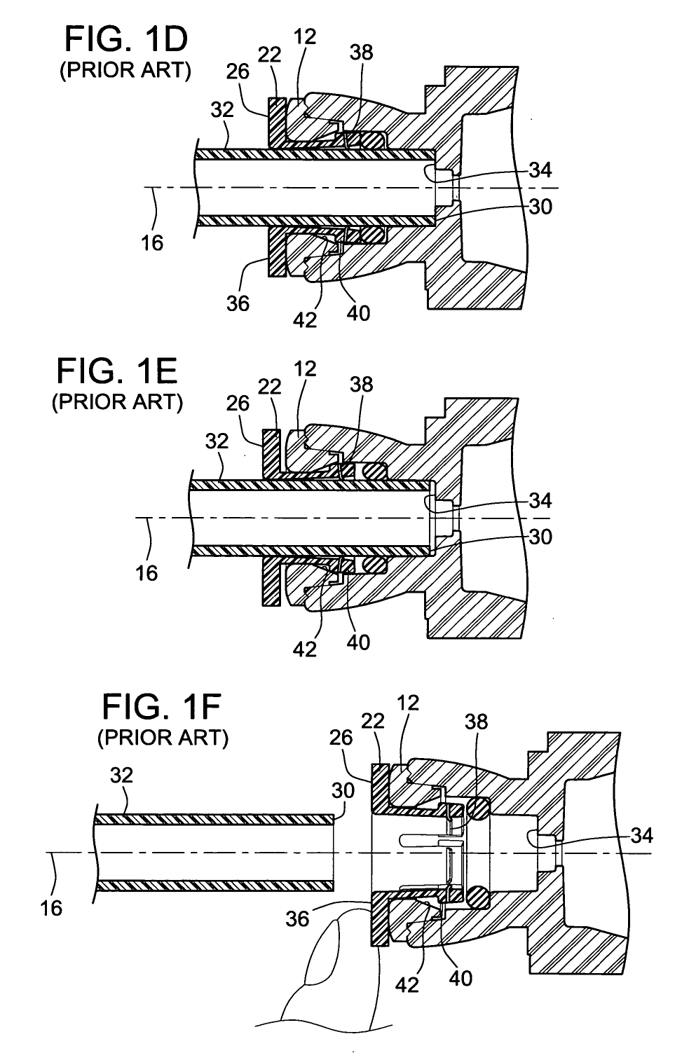

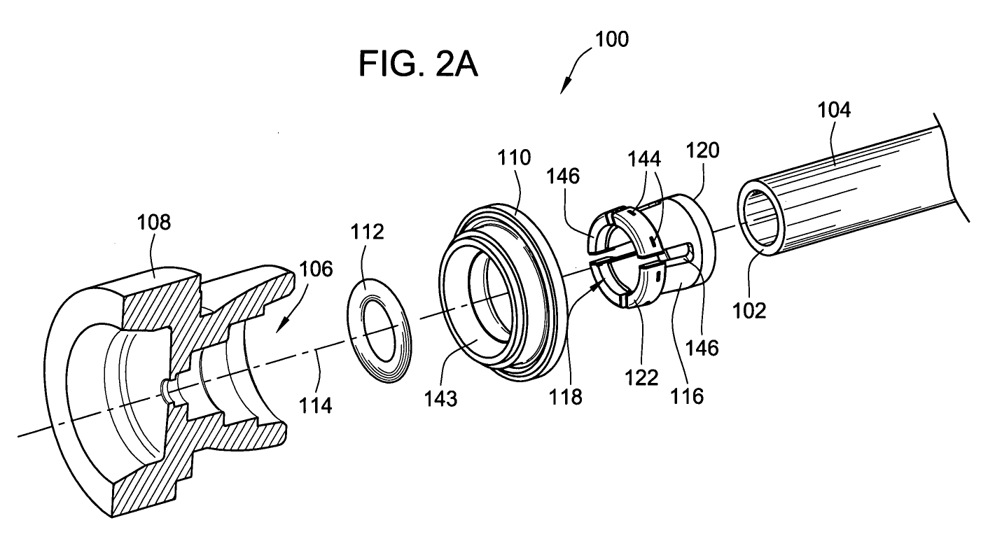

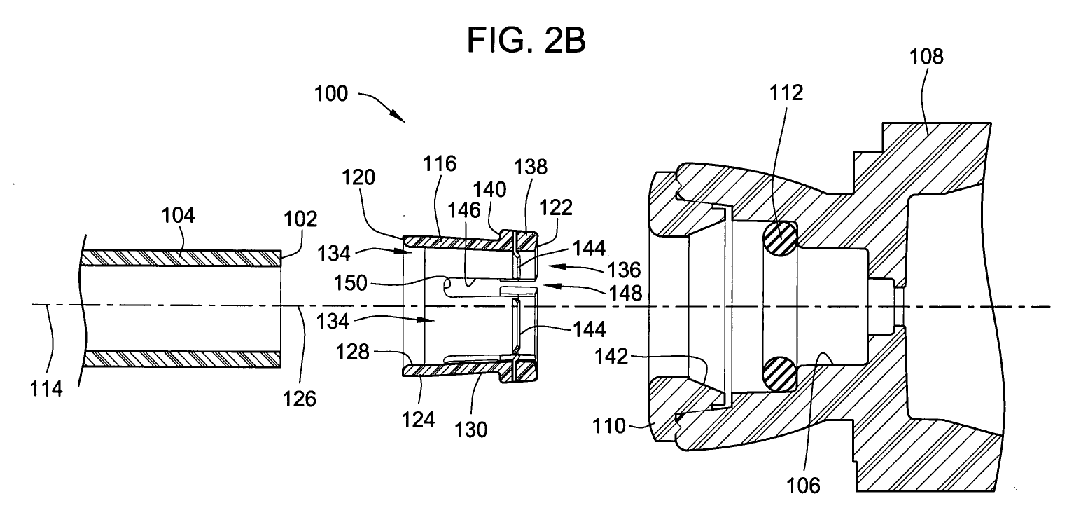

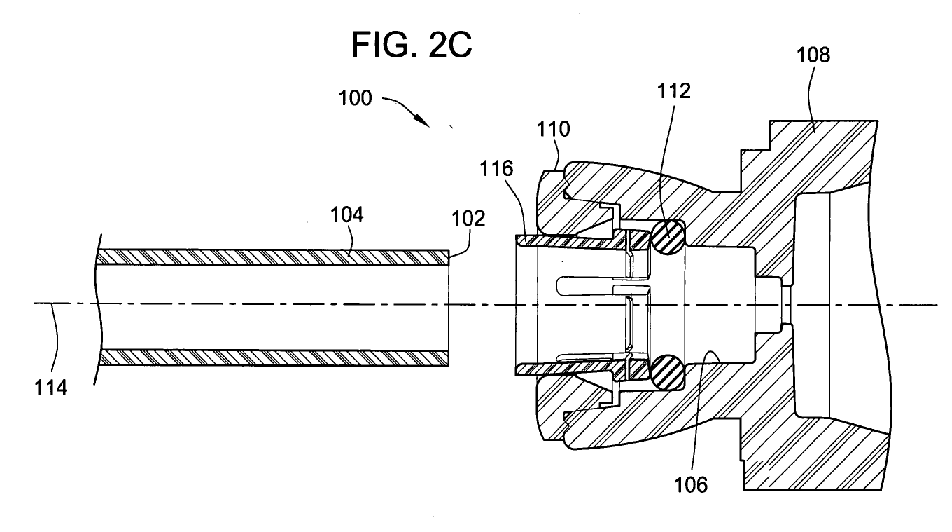

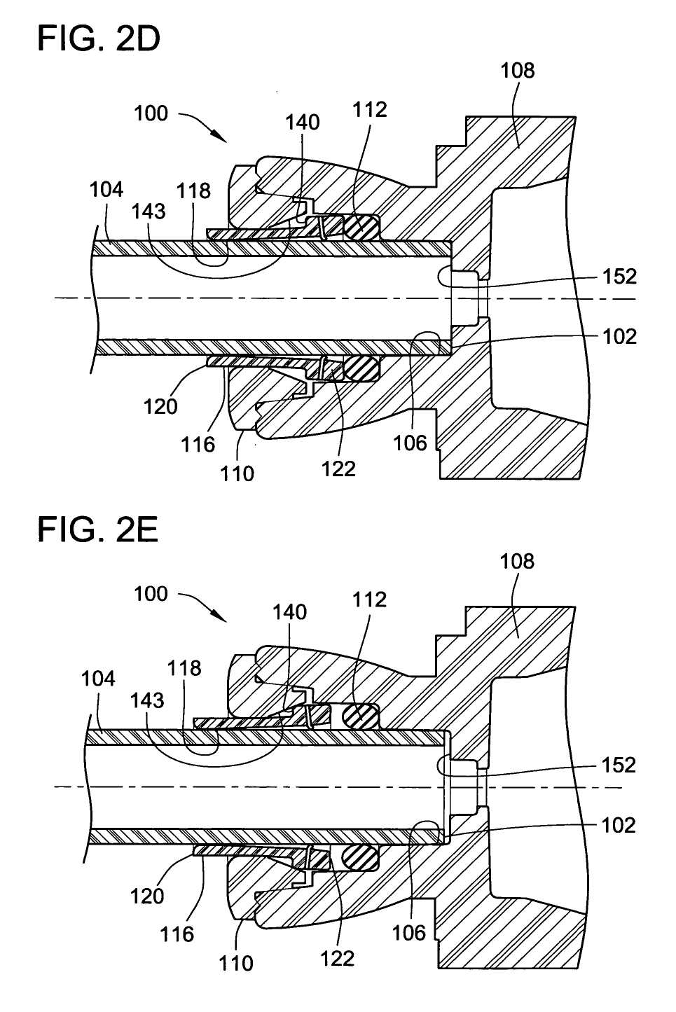

FIG. 2A shows a first exemplary embodiment of a tamper-proof, push-in, quick-connect apparatus 100 for attaching a distal end 102 of a tube 104 to a fluid port 106 of a fluid element 108 in the form of a coupling. The exemplary embodiment of the tamper-proof apparatus of FIG. 1A, include a cap-collar 110 and an o-ring 112 adapted for insertion, along an axis of insertion 114 into the fluid port 106 of the fluid element 108. The tamper-proof apparatus further includes a flangeless collet 116, having a bore 118 extending therethrough from a first end 120 of the collet to a second end 122 of the collet 116. The collet 116 which is adapted for insertion into the cap-collar 110. The bore 118 in the collet 116 is sized for receiving the distal end 102 of the tube 104.

As shown in FIGS. 1A and 1B, the flangeless collet 116 includes a substantially right circular cylinder-shaped sidewall 124 disposed about a longitudinal axis 126 of the collet 110 which extends substantially coincident with the axis of insertion 114 when the collet 110 is installed within the port 106 of the fluid element 108. The sidewall 124 of the collet has an inner surface 128 and an outer surface 130 thereof extending along the longitudinal axis 126 of the collet 110 from the first to the second ends 120, 122 of the collet 110.

The inner surface 128 of the sidewall 124 of the collet 110 defines the bore 118, which extends through the collet 110 along the longitudinal axis 126 and has a first axially facing opening 134 at the first end 120 of the collet 110 and a second axially facing opening 136 at the second end 122 of the collet 110.

The collet 116 is configured to receive the distal end 102 of the tube 104 at the first end 120 of the collet 116, and to allow sliding passage of the distal end 102 of the tube 104 through the bore 118 and the collet 116 and beyond the second end 122 of the collet 116, when the collet 116 is not installed in the port 106, or when the collet 116 is installed in the port 106 and pushed in along the insertion axis 114 to a tube insertion position, as shown in FIG. 2D, within the port 106. The collet 116 is further configured such that the collet 116 grips the outer surface of the tube 104 when the collet 116 is pulled out along the insertion axis 114 to a gripping position, as shown in FIG. 2E, while installed in the port 106.

As will be understood from the following description, and the accompanying drawings, the collet 116 of the exemplary embodiment of the tamper-proof apparatus 100 is configured adjacent the second end 122 of the collet 116 for gripping the outer surface of the tube 104 when the collet 116 is moved from the insertion position shown in FIG. 2D to the gripping position shown in FIG. 2E, while the collet 116 is installed in the port 106 and the tube 104 is extending through the bore 118 in the collet 116.

As best seen in FIG. 2B, the outer surface 130 of the sidewall 124, of the flangeless collet 120, includes outwardly projecting ridges 138 extending generally radially outward from the second end 122 of the collet 116. The outwardly projecting ridges 138 define ramp surfaces 140 oriented such that force applied to the ramp surface 140 when the collet 116 is moved toward the gripping position will cause the bore 118 of the collet to be constricted adjacent the second end 122 of the collet 116. Specifically, the inner surface 142 of the cap-collar 110, of the exemplary embodiment, includes a corresponding ramp-like surface 143, angled to engage the ramp surfaces 140 of the collet 116, to thereby cause progressive construction of the second end 122 of the collet 116.

The cap-collar 110 includes a corresponding inner surface 142 thereof, adapted to operatively engage the ramp surfaces 140 of the outwardly projecting ridges 138 of the collet 116. The collet 116 of the exemplary embodiment of the tamper-proof apparatus 100 also includes a plurality of barbs 144 extending generally radially inward from the inside surface 128 of the sidewall 124 of the collet 116 for gripping the tube 104. The barbs 14 of the exemplary embodiment, are preferentially angled toward the second end 122 of the collet 116 so that the distal end 102 of the tube 104 will slide across the barbs 144 as the tube 104 is inserted into the collet 116 and then bite into the tube 104 to resist movement of the tube 104 with respect to the collet 116 after the distal end 102 has been inserted into the collet 116.

The collet 116 further includes a plurality of slots 146 extending axially from the second end 122 of the sidewall 124 of the collet 116. In the exemplary embodiment, the slots 146 include an open end 148 thereof defining circumferential openings in the sidewall 124 at the second end 122 of the collet 116. The opposite end of each slot is closed by a blind end 150 of the slot disposed axially from the second end 122 of the collet 116.

In the exemplary embodiment, the closed end of the slots is formed by a U-shaped bight joining two substantially straight, axially extending sidewalls of the slot 146. It will be understood, by those having skill in the art, however, that in other embodiments of the invention, the slots may have other substantially different configurations. For example, the blind end 150 of the slots may take the form of a substantially circular opening extending through the sidewall, with the sidewalls of the slot 146 being straight, curved, or some combination thereof, and spaced apart less than the diameter of the circular opening, to form a slot having a keyhole shape. In addition, it should be noted that, although the exemplary embodiment of the collet 116 includes four slots 146, and other embodiments of the invention a fewer or greater number of slots may be utilized.

It will further be noted, that in the exemplary embodiment of the collet 116, the sidewall 124 of the collet 116, although substantially right-circular cylindrical-shaped, is tapered slightly inward from the first to the second ends 120, 122 of the collet 116 in such a manner that the inner wall 128 of the collet 116 applies a small gripping force to the tube 104 when it is inserted through the collet 116.

Operation of the exemplary embodiment 100 of the tamper-proof, push-in, quick-connect apparatus 100 is shown semi-diagrammatically in the sequence of views of FIGS. 2B-2E, respectively. To connect the distal end 102 of the tube 104 to the fluid port 106 of the fluid element 108, the cap-collar 110 and o-ring 112 are first installed into the fluid port 106 as shown in FIG. 2B.

It should be noted, that in the exemplary embodiment, the cap-collar 110 and the fluid element 108, are illustrated as both being fabricated from a non-metallic material such as a plastic, with the cap-collar 110 being welded into the mouth of the fluid port 106 of the fluid element 108. In other embodiments of the invention, other materials, and other methods, such as screw threads or fasteners, may be utilized to join a cap-collar according to the invention to a fluid element. It is further noted, that in some embodiments of the invention, it may be desirable to form the fluid port of a fluid element to integrally include the salient features of a cap-collar, according to the invention, rather than providing a separate cap-collar which is then attached to the fluid element.

After the cap-collar 110 and o-ring 112 are installed into the fluid port 106, the collet 116 is inserted into the cap-collar 110, as shown in FIG. 2C.

As shown in FIG. 2D, the distal end 102 of the tube 104 is then manually pushed along the axis of insertion 114 straight into and through the collet 116, until it abuts a stop shoulder 152 in the port 106. As the distal end 102 of the tube 104 is pushed further through the bore 118 of the collet 116, the slight constriction of the bore 118 of the collet 116 adjacent the second end 122 of the collet 116, together with the barbs 144 sliding along the surface of the tube 104, cause the collet 116 to be pulled along with the tube 104 into the bore 106. In the exemplary embodiment, the maximum extent of possible travel of the collet 116 into the port 106 is limited by the second end 122 of the collet 116 coming into contact with the o-ring 112. This movement of the collet 116 into the port 106 during installation, and causes the complementary ramp-like surfaces 140, 143 of the collet 116 and cap-collar to be disengaged during insertion of the distal end 102 of the tube 104 into the fluid port 106, as shown in FIG. 2D.

After the distal end of the tube 102 is pushed into contact with the shoulder 152 of the port 106 in the fluid element 108, a slight pulling force is manually exerted on the tube 104 relative to the cap-collar 110. As the tube 104 is pulled away from the cap-collar 110, the slight gripping force resulting from the tapered configuration of the bore 118 in the collet 116, together with additional force generated as the barbs 144 bite into the outer surface of the tube 104, cause the collet 116 to move with the tube 104 and toward the cap-collar 110, to bring the ramp surfaces 140 of the collar into engagement with the ramp-like surface 143 of the cap-collar 110, to thereby produce a wedging action between the cooperating ramp-like features 140, 143 on the collet 116 and cap-collar 110, which in turn causes constriction of the second end 122 of the collet 116 in such a manner that the second end 122 of the collet 116 grips the tube 104 and causing the barbs 144 to bite further into the tube 104.

It will be understood, by those having skill in the art, that once the distal end 102 of the tube 104 has been pulled only a short distance away from the shoulder 152 of the port 106, the configuration of the collet 116 and cap-collar 110 will cause the collet 116 to grip the tube 104 so tightly, that further pulling force exerted on the tube will not result in any further appreciable relative motion between the tube 104 and the collet 116. It will be further understood, that because the collet 116 of the invention is flangeless, it is virtually impossible to push the collet 116 back into the fluid port 106 with finger or thumb pressure, thereby making the connection formed by the invention substantially tamper-proof. It is further noted, that although the first end 120 of the collet 116 of the exemplary embodiment is exposed outside of the cap-collar 110 when the collet 116 is fully locked onto the tube 104, the sidewall 124 of the collet 116 is so thin that it would also be difficult to push the collet 116 back into the port 106, even if a tool were utilized to apply force to the first end 120 of the collet 116. In other embodiments of the invention it may be desirable to have the collet 116 configured in such a manner that the first end 120 of the sidewall 124 does not extend beyond the cap-collar 110, when the collet 116 is fully engaging the tube 104, to thereby make it virtually impossible to push the collet 116 back into the port 106, even with the assistance of a tool.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A push-in quick-connect apparatus for attaching a distal end of a tube to a fluid port of a fluid element, wherein the port defines an axis of insertion for the tube, the quick-connect apparatus comprising:
a flangeless collet including a substantially right circular cylinder-shaped sidewall disposed about a longitudinal axis, the sidewall having an inner surface and an outer surface thereof extending along the longitudinal axis of the collet from a first to a second end of the collet;
the inner surface of the sidewall defining a bore extending through the collet along the longitudinal axis and having a first axially facing opening at the first end of the collet and a second axially facing opening at the second end of the collet;
the collet being configured to receive the distal end of the tube at the first end of the collet and allow sliding passage of the distal end of the tube through the bore and beyond the second end of the collet when the collet is not installed in the port or when the collet is installed within the port and pushed in along the insertion axis to a tube insertion position within the port;
the collet being further configured such that the collet grips the outer surface of the tube when the collet is pulled out along the insertion axis to a gripping position while installed in the port.

2. The apparatus of claim 1, wherein the collet is configured adjacent its second end for gripping the outer surface of the tube when the collet is moved to the gripping position while the collet is installed in the port and the tube is extending through the bore in the collet.

3. The apparatus of claim 2, wherein the outer surface of the sidewall adjacent the second end of the collet includes outwardly projecting ridges defining ramp surfaces oriented such that force applied to the ramp surface when the collet is moved toward the gripping position will cause the bore of the collet to be constricted adjacent the second end of the collet.

4. The apparatus of claim 3, wherein the collet further includes at least one slot in the sidewall extending from the second end of the sidewall.

5. The apparatus of claim 4, wherein the slot includes an open end thereof defining a circumferential opening at the sidewall at the second end of the collet and is closed by a blind end of the slot disposed axially from the second end of the collet.

6. The apparatus of claim 5, wherein the collet includes one or more barbs extending generally radially inward from the inside surface of sidewall of the collet for gripping the tube.

7. The apparatus of claim 1, further comprising a cap-collar adapted for attachment to the fluid element and having a portion thereof configured for operatively engaging the collet when the collet is installed into the cap-collar.

8. The apparatus of claim 7, wherein:
the outer surface of the sidewall adjacent the second end of the collet includes outwardly projecting ridges defining ramp surfaces oriented such that force applied to the ramp surface when the collet is moved toward the gripping position will cause the bore of the collet to be constricted adjacent the second end of the collet; and
the cap-collar includes an inner surface thereof adapted to operatively engage the ramp surfaces of the outwardly projecting ridges of the collet.

9. The apparatus of claim 7, wherein the inner surface of the cap-collar includes complementary ramp surfaces for engaging the ramp surfaces of the outwardly projecting ridges of the collet.

10. The apparatus of claim 1, wherein the outer surface of the sidewall adjacent the second end of the collet includes outwardly projecting ridges defining ramp surfaces oriented such that force applied to the ramp surface when the collet is moved toward the gripping position will cause the bore of the collet to be constricted adjacent the second end of the collet.

11. The apparatus of claim 10, further comprising a cap-collar having an inner surface thereof adapted to operatively engage the ramp surfaces of the outwardly projecting ridges of the collet.

12. The apparatus of claim 1, wherein the outer surface of the sidewall adjacent the second end of the collet includes outwardly projecting ridges defining ramp surfaces oriented such that force applied to the ramp surface when the collet is moved toward the gripping position will cause the bore of the collet to be constricted adjacent the second end of the collet.

13. The apparatus of claim 12, wherein the collet includes one or more barbs extending generally radially inward from the inside surface of sidewall of the collet.

14. The apparatus of claim 12, wherein the collet further includes at least one slot in the sidewall extending from the second end of the sidewall.

15. The apparatus of claim 14, wherein the slot includes an open end thereof defining a circumferential opening at the sidewall at the second end of the collet and is closed by a blind end of the slot disposed axially from the second end of the collet.

16. A push-in quick-connect apparatus push-in quick-connect apparatus for attaching a distal end of a tube to a fluid port of a fluid element, wherein the port defines an axis of insertion for the tube, the quick-connect apparatus comprising a flangeless collet, and a cap-collar;
the collet including a substantially right circular cylinder-shaped sidewall disposed about a longitudinal axis, the sidewall having an inner surface and an outer surface thereof extending along the longitudinal axis of the collet from a first to a second end of the collar;
the inner surface of the sidewall of the collet defining a bore extending through the collet along the longitudinal axis and having a first axially facing opening at the first end of the collet and a second axially facing opening at the second end of the collet;
the collet being configured to receive the distal end of the tube at the first end of the collet and allow sliding passage of the distal end of the tube through the bore and beyond the second end of the collet when the collet is not installed in the port;
the cap-collar being adapted for receiving the collet therein and having a portion thereof configured for operatively engaging the collet when the collet is installed into the cap-collar;
the collet and cap-collar including complementary ramp surfaces engaging one another when the first end of the flangeless collet is moved away from the cap-collar, while the collet is installed in the cap-collar, and disengaging from one another when the first end of the collet is moved toward the cap-collar while the collet is installed in the cap-collar, whereby the collet is constricted adjacent the second end of the collet by engagement of the complementary ramp surfaces, with such constriction being relaxed when the complementary ramped surfaces are not in engagement.

17. The apparatus of claim 16, wherein the collet is configured such that progressive movement of the first end of the collet away from the cap-collar results in progressively greater constriction of the second end of the collet, and such that progressive movement of the first end of the collet toward the cap-collar results in progressively less constriction of the second end of the collet.

18. The apparatus of claim 17, wherein the first end of the collet is configured such that it cannot readily be pushed toward the cap-collar after the second end of the collet is constricted while the distal end of the tube is extending through the collet.

19. A method for attaching a distal end of a tube to a fluid port of a fluid element the method comprising, attaching the distal end of the tube to the port with a push-in, quick-connect apparatus having a flangeless collet.

20. The method of claim 19, further including configuring the quick connect apparatus in such a manner that the flangeless collet cannot readily be moved with respect to the tube after the distal end of the tube is attached to the fluid element.
